(19) United States
(12) Patent Application Publication
(10) Pub. No.: US 2022/0324287 A1
(43) Pub. Date: Oct. 13, 2022

(54) VEHICLE

(71) Applicants: TOYOTA JIDOSHA KABUSHIKI KAISHA, Toyota-shi (JP); SUBARU CORPORATION, Tokyo (JP)

(72) Inventors: Shotaro INOUE, Nisshin-shi (JP); Takafumi Miyahara, Kariya-city (JP)

(73) Assignees: TOYOTA JIDOSHA KABUSHIKI KAISHA, Toyota-shi (JP); SUBARU CORPORATION, Tokyo (JP)

(21) Appl. No.: 17/709,749

(22) Filed: Mar. 31, 2022

(30) Foreign Application Priority Data
Apr. 7, 2021 (JP) 2021-065452

(51) Int. Cl. B60H 1/00; B60H 1/22

(52) U.S. Cl. CPC B60H 1/00292; B60H 1/2215; B60H 2001/2246

(57) ABSTRACT

A vehicle includes a steering column, a radiant heater arranged in the steering column and configured to radiate radiant heat toward an area below the steering column, an instrument panel that defines part of an opening where the steering column passes and that extends in a lateral direction of the vehicle, an inside air sensor adjoining the opening in the instrument panel and configured to detect an indoor temperature of the vehicle, and a lower cover arranged below the steering column and defining the opening together with the instrument panel. At least the instrument panel or the lower cover includes a shielding wall positioned between the radiant heater and the inside air sensor.

### CROSS-REFERENCE TO RELATED APPLICATION

This application claims priority to Japanese Patent Application No. 2021-065452 filed on Apr. 7, 2021, incorporated herein by reference in its entirety.

### BACKGROUND

### 1. Technical Field

The technology disclosed herein relates to a vehicle.

### 2. Description of Related Art

Japanese Unexamined Patent Application Publication No. 2010-089630 (JP 2010-089630 A) describes a vehicle. In this vehicle, a radiant heater is arranged on a steering column. This radiant heater radiates radiant heat toward a space below the steering column, that is, the vicinity of the knee of a user sitting on a driver's seat.

### SUMMARY

Vehicles often include an air conditioning unit that cools and heats a vehicle cabin. This kind of air conditioning unit adjusts the temperature in the vehicle cabin to a temperature desired by a user by detecting the temperature in the vehicle cabin with an inside air sensor. When such a vehicle further includes the radiant heater as described above, the radiant heat from the radiant heater may influence the temperature detected by the inside air sensor. To avoid such influence, a sufficient distance may be secured between the radiant heater and the inside air sensor. On the other hand, to correctly adjust the temperature in the vehicle cabin in response to the request of the user who drives the vehicle, it is preferable to arrange the inside air sensor near the user. Therefore, it is difficult to secure a sufficient distance between the radiant heater and the inside air sensor.

In view of the circumstances described above, the present specification provides a technology for reducing the influence of the radiant heater on the inside air sensor even when the inside air sensor and the heater are arranged relatively close to each other.

The technology disclosed herein is embodied as a vehicle. A vehicle according to one aspect of the present disclosure includes a steering column, a radiant heater arranged in the steering column and configured to radiate radiant heat toward an area below the steering column, an instrument panel that defines part of an opening where the steering column passes, the instrument panel extending in a lateral direction of the vehicle, an inside air sensor adjoining the opening in the instrument panel and configured to detect an indoor temperature of the vehicle, and a lower cover arranged below the steering column and defining the opening together with the instrument panel. At least one of the instrument panel and the lower cover includes a shielding wall positioned between the radiant heater and the inside air sensor.

In the vehicle described above, the inside air sensor that detects the indoor temperature of the vehicle adjoins the opening in the instrument panel. According to such a structure, the inside air sensor is arranged in the vicinity of a user who drives the vehicle to correctly detect a temperature actually sensed by the user. The radiant heater arranged in the steering column adjoins the inside air sensor, and the shielding wall is provided between the inside air sensor and the steering column. As a result, it is possible to reduce the occurrence of a case where the radiant heat radiated from the radiant heater or air heated by the radiant heat reaches the inside air sensor. Since the influence of the radiant heater on the inside air sensor is reduced, the inside air sensor can accurately detect an actual temperature in a vehicle cabin.

In the vehicle according to the aspect described above, the shielding wall may be provided on the lower cover.

In the vehicle according to the aspect described above, the shielding wall may be integrated with the lower cover.

In the vehicle according to the aspect described above, the shielding wall may be covered with the instrument panel.

In the vehicle according to the aspect described above, the shielding wall may extend in a front-rear direction of the vehicle from the lower cover toward the instrument panel, and an end of the shielding wall that faces a back surface of the instrument panel may extend along the back surface of the instrument panel.

In the vehicle according to the aspect described above, a clearance may be provided between the end of the shielding wall and the back surface of the instrument panel.

In the vehicle according to the aspect described above, the end of the shielding wall may extend along the back surface of the instrument panel to keep the clearance uniform.

In the vehicle according to the aspect described above, the lower cover may include a body portion arranged below the steering column, and a fixing portion extending from the body portion toward the instrument panel and fixed to the instrument panel. The shielding wall may be integrated with the fixing portion.

In the vehicle according to the aspect described above, the shielding wall may be visible through a gap around the steering column in the opening in the instrument panel, and the inside air sensor may be positioned behind the shielding wall in a line-of-sight direction in which the shielding wall is visible.

The vehicle according to the aspect described above may further include an airbag arranged on an inner side of the lower cover. The lower cover may be configured to be broken by the airbag when the airbag is inflated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating the structure of a vehicle 10 of an embodiment;

FIG. 2 is a front view of an instrument panel 24, in which only a portion of the instrument panel 24 around a driver's seat is mainly illustrated and a portion around a passenger seat is omitted, and in which a hatching indicates a radiant heater 40;

FIG. 3 is a diagram illustrating a positional relationship among a shielding wall 52, the radiant heater 40, and an inside air sensor 44 viewed from the rear in a front-rear direction of the vehicle 10, in which a center panel 24b is omitted;

FIG. 4 is a diagram illustrating a positional relationship among the shielding wall 52, the radiant heater 40, and the inside air sensor 44 viewed from the front of the vehicle 10, in which a hose 48 is represented by dashed lines;

FIG. 5 is a diagram illustrating results of an experiment for verifying effects of the shielding wall 52;

FIG. 6 is a diagram illustrating a clearance C between the shielding wall 52 and a back surface 25 of the center panel 24b; and

FIG. 7 is a diagram illustrating a line-of-sight direction S in which the shielding wall 52 is visible through a gap around a steering column 34, and a positional relationship between the inside air sensor 44 and the shielding wall 52.

### DETAILED DESCRIPTION OF EMBODIMENTS

In one embodiment of the present technology, a shielding wall may be provided on a lower cover. In this case, the shielding wall may be integrated with the lower cover. According to such a structure, it is possible to avoid the occurrence of abnormal noise between the shielding wall and the lower cover when vibration occurs along with traveling of a vehicle. In addition, workability is improved because work of attaching the shielding wall to the lower cover is unnecessary. The shielding wall need not be integrated with the lower cover, and may be provided as a separate component from the lower cover.

In the embodiment described above, the shielding wall may be covered with an instrument panel. In other words, the shielding wall may be positioned behind the instrument panel when viewed from a vehicle cabin. According to such a structure, exposure of the shielding wall to the vehicle cabin can be avoided. Therefore, the design in the vehicle cabin is improved.

In the embodiment described above, the shielding wall may extend in a front-rear direction of the vehicle from the lower cover toward the instrument panel. In this case, an end of the shielding wall that faces a back surface of the instrument panel may extend along the back surface of the instrument panel. According to such a structure, it is possible to effectively reduce or avoid the occurrence of a case where radiant heat radiated from a radiant heater or air heated by the radiant heat reaches an inside air sensor.

In the embodiment described above, a clearance may be provided between the end of the shielding wall and the back surface of the instrument panel. According to such a structure, it is possible to avoid unexpected contact between the shielding wall and the instrument panel when vibration occurs along with the traveling of the vehicle. Therefore, the occurrence of abnormal noise can be reduced or avoided.

In the embodiment described above, the end of the shielding wall may extend along the back surface of the instrument panel to keep a uniform clearance between the end of the shielding wall and the back surface of the instrument panel. According to such a structure, the influence of the radiant heater on the inside air sensor can be reduced effectively, and the occurrence of abnormal noise can be reduced or avoided effectively. The clearance between the end of the shielding wall and the back surface of the instrument panel need not be kept uniform. For example, the size of the clearance may vary depending on components of the instrument panel or the shapes of the components.

In one embodiment of the present technology, the lower cover may include a body portion arranged below a steering column, and a fixing portion extending from the body portion toward the instrument panel and fixed to the instrument panel. In this case, the shielding wall may be integrated with the fixing portion. According to such a structure, when vibration occurs along with the traveling of the vehicle, the shielding wall integrated with the fixing portion is supported by the instrument panel where the fixing portion is fixed. Therefore, it is possible to reduce or avoid the occurrence of abnormal noise due to unexpected contact between the shielding wall and other components including the instrument panel.

In one embodiment of the present technology, the shielding wall may be visible through a gap (i.e., through a part of the opening) around the steering column in the opening in the instrument panel, and the inside air sensor may be positioned behind the shielding wall in a line-of-sight direction in which the shielding wall is visible. According to such a structure, the shielding wall can avoid or reduce the possibility that the inside air sensor (or a hose connecting the inside air sensor and an air conditioning unit) is seen when a user unexpectedly sees a back side of the instrument panel through the gap. Therefore, the design in the vehicle cabin is improved.

In one embodiment of the present technology, an airbag may be provided and may be arranged on an inner side of the lower cover. In this case, the lower cover may be configured to be broken by the airbag when the airbag is inflated. The specific kind and structure of the airbag are not particularly limited.

A vehicle 10 of an embodiment will be described with reference to the drawings. The vehicle 10 is a so-called automobile, and is a vehicle that travels over a road surface. In the drawings, a direction FR indicates forward in a front-rear direction of the vehicle 10, and a direction RR indicates rearward in the front-rear direction of the vehicle 10. A direction LH indicates leftward in a lateral direction of the vehicle 10, and a direction RH indicates rightward in the lateral direction of the vehicle 10. A direction UP indicates upward in a vertical direction of the vehicle 10, and a direction DW indicates downward in the vertical direction of the vehicle 10. The front-rear direction of the vehicle 10, the lateral direction of the vehicle 10, and the vertical direction of the vehicle 10 may herein be referred to simply as “front-rear direction”, “lateral direction”, and “vertical direction”, respectively.

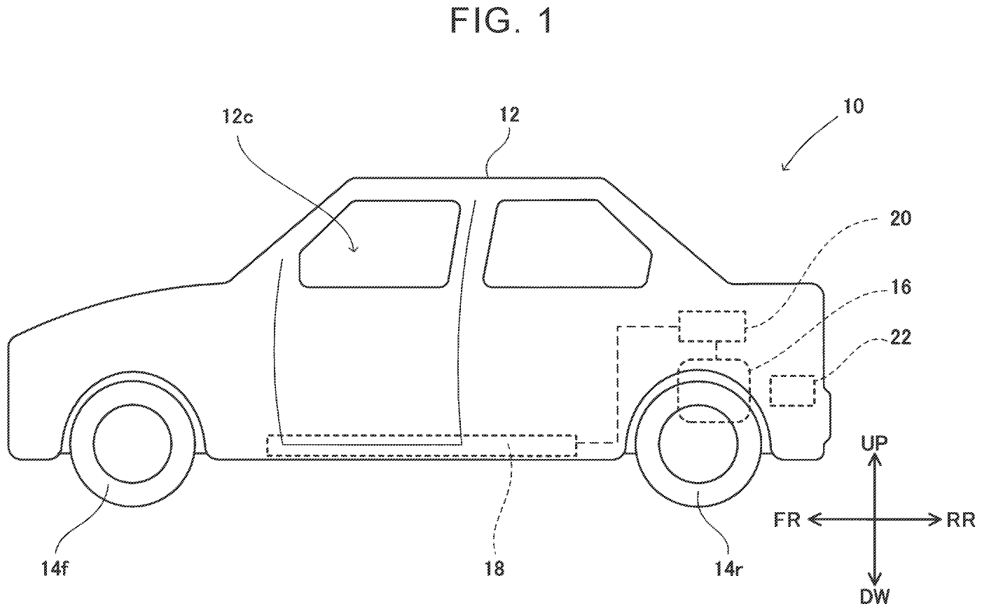

As illustrated in FIG. 1, the vehicle 10 includes a body 12 and a plurality of wheels 14f and 14r. The body 12 has a vehicle cabin 12c as a space for occupants. The wheels 14f and 14r are rotatably attached to the body 12. The wheels 14f and 14r include a pair of front wheels 14f positioned at the front of the body 12 and a pair of rear wheels 14r positioned at the rear of the body 12. The front wheels 14f are disposed coaxially with each other, and the rear wheels 14r are also disposed coaxially with each other. The number of wheels 14f and 14r is not limited to four. Although there is no particular limitation, the body 12 is made of a metal such as steel or an aluminum alloy.

As illustrated in FIG. 1, the vehicle 10 further includes a motor 16, a battery unit 18, a power control unit 20 (hereinafter referred to as “PCU 20”), and an electronic control unit 22 (hereinafter referred to as “ECU 22”). For example, the motor 16 is connected to the rear wheels 14r via a drive shaft (not illustrated). Accordingly, the motor 16 can drive the rear wheels 14r. The battery unit 18 includes a plurality of secondary battery cells, and is repeatedly rechargeable with external electric power. The battery unit 18 is connected to the motor 16 via the PCU 20, and supplies electric power to the motor 16. The PCU 20 includes a direct current-to-direct current (DC-DC) converter and/or an inverter, and controls the electric power to be transferred between the battery unit 18 and the motor 16. The ECU 22 includes a processor, and gives a control command to the PCU 20 in response to, for example, a user's operation.

The motor 16 need not drive the rear wheels 14r but may drive at least one of the wheels 14f and 14r. The vehicle 10 may further include other prime movers such as an engine in place of or in addition to the motor 16. The vehicle 10 may include other power sources such as a fuel cell unit or a solar cell panel in addition to or in place of the battery unit 18. Thus, the vehicle 10 is not limited to the battery-powered electrified vehicle, but may be an engine vehicle or another kind of electrified vehicle such as a hybrid electric vehicle, a fuel cell electric vehicle, or a solar car.

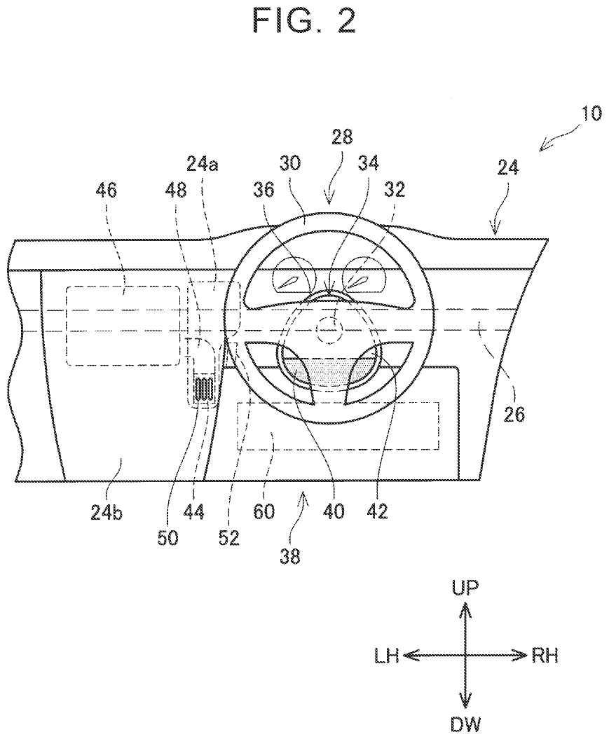

As illustrated in FIG. 2, the vehicle 10 further includes an instrument panel 24 and an instrument panel reinforcement 26 (hereinafter referred to as “instrument panel R/F 26”). The instrument panel 24 is a member for improving design in the vehicle cabin 12c of the vehicle 10. The instrument panel R/F 26 is a member constituting vehicle body of the vehicle 10. The instrument panel R/F 26 extends in the lateral direction of the vehicle 10 and couples a right side and a left side of the vehicle body. The instrument panel 24 extends in the lateral direction of the vehicle 10 and is attached to the instrument panel R/F 26 from the rear in the front-rear direction of the vehicle 10. The instrument panel 24 is mainly made of a resin, and the instrument panel R/F 26 is made of a metal.

As illustrated in FIGS. 2 to 4, the instrument panel 24 includes a base panel 24a and a center panel 24b. The base panel 24a is a member constituting a main part including the skeleton of the instrument panel 24. The center panel 24b is a so-called interior member exposed to the vehicle cabin 12c. The base panel 24a has a plurality of attachment holes. Interior members such as the center panel 24b and a lower cover 38 are removably attached to the rear part (that is, a part facing the vehicle cabin 12c) of the base panel 24a via the attachment holes. The center panel 24b is arranged between a driver's seat and a passenger seat. Although there is no particular limitation, at least a part of the instrument panel 24 may be made of a foam.

As illustrated in FIG. 2, the vehicle 10 further includes a steering device 28. The steering device 28 includes a steering wheel 30, a steering shaft 32, and a steering column 34. The steering column 34 is arranged in an opening 36 provided in the instrument panel 24. The steering wheel 30 is arranged in front of the driver's seat and is operated by the user's hands. The rear end of the steering shaft 32 is connected to the steering wheel 30 and is fixed to the steering wheel 30 in a non-rotatable manner. The steering column 34 has a through hole where the steering shaft 32 passes, and rotatably supports the steering shaft 32. As a result, the steering wheel 30 is rotatably supported on the steering column 34 together with the steering shaft 32. The rotation angle of the steering shaft 32 is detected by a sensor (not illustrated), and the steering angle of the front wheels 14f is adjusted based on a value detected by the sensor. Thus, the user can change, for example, the angle of the front wheels 14f by operating the steering wheel 30. Although there is no particular limitation, the steering shaft 32 may be supported by the instrument panel R/F 26 via a bracket (not illustrated) or the like. The steering device 28 may be configured such that the position of the steering wheel 30 can be adjusted depending on, for example, a driving posture of the user.

As illustrated in FIG. 2, the instrument panel 24 defines part of the opening 36. The instrument panel 24 mainly defines an upper portion of the opening 36. That is, a lower side of the opening 36 is open at the instrument panel 24, and the instrument panel 24 defines a substantially semicircular arc-shaped space. The opening 36 is positioned in front of the driver's seat. The steering shaft 32 and the steering column 34 are arranged to extend through the opening 36. The portions of the instrument panel 24 that define part of the opening 36 need not be the base panel 24a and the center panel 24b. Any component constituting the instrument panel 24 may define part of the opening 36.

As illustrated in FIGS. 2 to 4, the vehicle 10 further includes the lower cover 38. The lower cover 38 is arranged below the steering column 34. Specifically, the lower cover 38 is arranged to define a lower portion of the opening 36. That is, the lower cover 38 defines the opening 36 together with the instrument panel 24. The lower cover 38 may define at least part of the lower portion of the opening 36.

As illustrated in FIG. 2, the vehicle 10 further includes an airbag 60. When a collision occurs with the vehicle 10, the airbag 60 is inflated to suppress or avoid strong contact between the occupant and the steering wheel 30, the instrument panel 24, or the like. The airbag 60 is arranged on a front side of the lower cover 38. For example, the lower cover 38 has a portion where the wall surface thickness is locally small (so-called thin portion). As a result, the lower cover 38 is broken from the thin portion as a starting point due to a load from the inflated airbag 60. The specific kind and structure of the airbag 60 are not particularly limited.

As illustrated in FIGS. 2 to 4, the vehicle 10 further includes a radiant heater 40. The radiant heater 40 can radiate radiant heat by energization. The radiant heater 40 is arranged in the steering column 34. For example, the radiant heater 40 is arranged on a column cover 42 provided on the steering column 34. The column cover 42 is a member that covers the steering column 34 between the instrument panel 24 and the steering wheel 30. Although there is no particular limitation, the radiant heater 40 is arranged along the lower surface of the column cover 42. As a result, the radiant heater 40 radiates the radiant heat toward an area below the steering column 34. Therefore, the radiant heater 40 can warm the vicinity of the knee of the user sitting on the driver's seat. The specific structure and shape of the radiant heater 40 are not particularly limited.

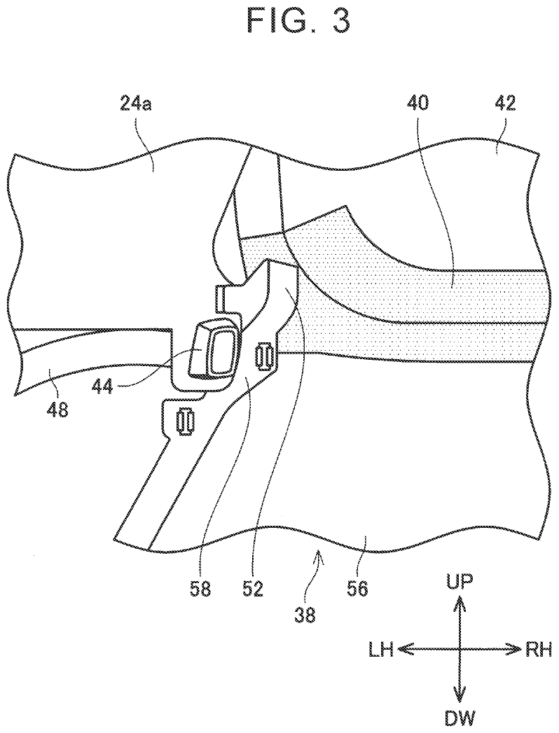

As illustrated in FIGS. 2 to 4, the vehicle 10 further includes an inside air sensor 44 and an air conditioning unit 46. The inside air sensor 44 includes, for example, a thermistor and can detect an indoor temperature of the vehicle 10. As illustrated in FIG. 3, the inside air sensor 44 is arranged on the base panel 24a of the instrument panel 24. For example, the inside air sensor 44 has an air inlet 44a. An air vent 50 provided at the center panel 24b is arranged behind the air inlet 44a (that is, on the vehicle cabin 12c side). The air inlet 44a is connected to the air conditioning unit 46 via a hose 48. As a result, air in the vehicle cabin 12c that is taken in through the air inlet 44a is sent to the air conditioning unit 46. The inside air sensor 44 detects a temperature of the air sent to the air conditioning unit 46. Conditioned air to be sent from the air conditioning unit 46 into the vehicle cabin 12c via a duct (not illustrated) is controlled based on the temperature detected by the inside air sensor 44.

As illustrated in FIGS. 2 to 4, the inside air sensor 44 adjoins the opening 36 defined by the instrument panel 24 and the lower cover 38. As described above, the radiant heater 40 is arranged in the steering column 34 passing through the opening 36. For this reason, the radiant heater 40 adjoins the inside air sensor 44. The term “adjoin” herein means “presence at a relatively short distance within a reachable range of the radiant heat radiated from the radiant heater 40”. The reachable range of the radiant heat radiated from the radiant heater 40 may vary as appropriate depending on, for example, the performance of the radiant heater 40 and arrangement of other components. For example, in the vehicle 10 of the present embodiment, both the steering column 34 having the radiant heater 40 and the inside air sensor 44 that detects the temperature in the vehicle cabin 12c are arranged on the same side in the lateral direction in the vehicle cabin 12c. With such arrangement, the radiant heater 40 and the inside air sensor 44 are likely to adjoin each other so closely that the radiant heat radiated from the radiant heater 40 may reach the inside air sensor 44.

As illustrated in FIGS. 2 to 4, the lower cover 38 has a shielding wall 52. The shielding wall 52 is positioned between the radiant heater 40 and the inside air sensor 44. That is, the shielding wall 52 is arranged on a straight line connecting the radiant heater 40 and the inside air sensor 44. For example, the shielding wall 52 is integrated with the lower cover 38. Moreover, the shielding wall 52 need not be integrated with the lower cover 38, and may be provided as a separate component from the lower cover 38.

In the vehicle 10 described above, the inside air sensor 44 that detects the indoor temperature of the vehicle 10 is provided, and adjoins the opening 36 in the instrument panel 24. According to such a structure, the inside air sensor 44 is arranged in the vicinity of the user who drives the vehicle 10 to correctly detect the temperature actually sensed by the user. The radiant heater 40 arranged in the steering column 34 adjoins the inside air sensor 44, and the shielding wall 52 is provided between the inside air sensor 44 and the steering column 34. As a result, it is possible to reduce the occurrence of a case where the radiant heat radiated from the radiant heater 40 or the air heated by the radiant heat reaches the inside air sensor 44. Since the influence of the radiant heater 40 on the inside air sensor 44 is reduced, the inside air sensor 44 can accurately detect the actual temperature in the vehicle cabin.

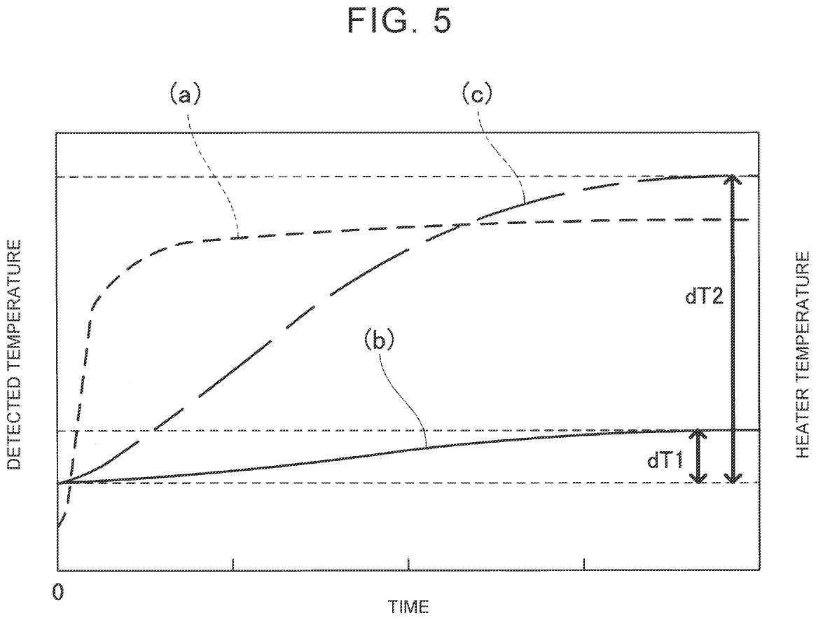

Regarding the points described above, results of an experiment for verifying the effects of the shielding wall 52 will be described with reference to FIG. 5. In FIG. 5, a graph (a) shows a temperature of the radiant heater 40, and a graph (b) shows a temperature detected by the inside air sensor 44 in a structure of an embodiment having the shielding wall 52. As a comparative example, a graph (c) shows a temperature detected by the inside air sensor 44 in a structure without the shielding wall 52. A horizontal axis represents a period of time elapsed from the time when the radiant heater 40 is activated. A vertical axis on a left side represents the temperature detected by the inside air sensor 44. A vertical axis on a right side represents the temperature of the radiant heater 40. A temperature range represented by the vertical axis on the right side differs from a temperature range represented by the vertical axis on the left side. The temperature in the vehicle cabin 12c is maintained at an almost constant temperature.

As shown in the graph (a), the temperature of the radiant heater 40 rapidly increases to a set temperature in a short period (for example, about 1 minute) after the radiant heater 40 is activated, and is then maintained at the substantially constant temperature. As shown in the graph (b), a temperature increase range dT1 of the temperature detected by the inside air sensor 44 is narrowed to a relatively small value even after the temperature of the radiant heater 40 increases significantly. As shown in the graph (c), in the structure without the shielding wall 52, a relatively wide temperature increase range dT2 is observed in the temperature detected by the inside air sensor 44 along with the increase in the temperature of the radiant heater 40. Thus, it is verified that the shielding wall 52 provided between the inside air sensor 44 and the steering column 34 can reduce the influence of the radiant heater 40 on the inside air sensor 44.

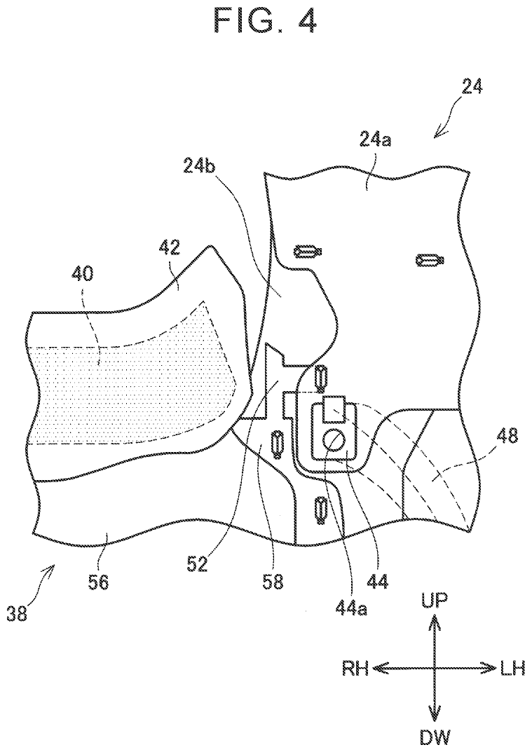

For example, as illustrated in FIGS. 3 and 4, the lower cover 38 is attached to the base panel 24a of the instrument panel 24 with clips. As described above, the center panel 24b is attached to the rear of the base panel 24a (that is, on the vehicle cabin 12c side). Therefore, the shielding wall 52 provided on the lower cover 38 is covered with the center panel 24b of the instrument panel 24. According to such a structure, exposure of the shielding wall 52 to the vehicle cabin 12c can be avoided, thereby improving the design in the vehicle cabin. The shielding wall 52 need not be covered with the instrument panel 24, and may be exposed to the vehicle cabin 12c depending on, for example, the shape of the instrument panel 24.

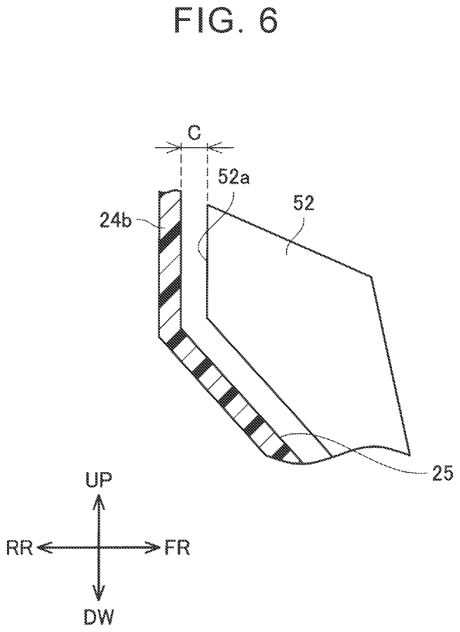

For example, as illustrated in FIG. 6, the shielding wall 52 extends in the front-rear direction of the vehicle 10 from the lower cover 38 toward the center panel 24b of the instrument panel 24. In this case, an end 52a of the shielding wall 52 that faces a back surface 25 of the center panel 24b extends along the back surface 25 of the center panel 24b. According to such a structure, it is possible to effectively reduce or avoid the occurrence of the case where the radiant heat radiated from the radiant heater 40 or the air heated by the radiant heat reaches the inside air sensor 44. Moreover, the shielding wall 52 provided on the lower cover 38 may extend in the front-rear direction of the vehicle 10 toward another component of the instrument panel 24 in place of or in addition to the center panel 24b.

For example, a clearance C is provided between the end 52a of the shielding wall 52 and the back surface 25 of the center panel 24b in FIG. 6 in addition to the above. Although there is no particular limitation, the end 52a of the shielding wall 52 extends along the back surface 25 of the center panel 24b to keep the clearance C uniform. According to such a structure, the influence of the radiant heater 40 on the inside air sensor 44 can be reduced effectively, and the occurrence of abnormal noise can be reduced or avoided effectively. Further, the clearance C need not be provided between the end 52a of the shielding wall 52 and the back surface 25 of the center panel 24b. Further, the clearance C between the end 52a of the shielding wall 52 and the back surface 25 of the center panel 24b need not be kept uniform. For example, the size of the clearance C may vary depending on the components of the instrument panel 24 or the shapes of the components.

For example, as illustrated in FIGS. 3 and 4, the lower cover 38 includes a body portion 56 and a fixing portion 58. The body portion 56 constitutes a design surface of the lower cover 38. The fixing portion 58 is provided to fix the lower cover 38 to an adjacent component or the like. The body portion 56 is arranged below the steering column 34. The fixing portion 58 extends from the body portion 56 toward the base panel 24a of the instrument panel 24 and is fixed to the base panel 24a. Although there is no particular limitation, the present embodiment adopts a structure in which the shielding wall 52 is integrated with the fixing portion 58 and supported stably. According to such a structure, it is possible to reduce or avoid the occurrence of abnormal noise due to unexpected contact between the shielding wall 52 and other components including the instrument panel 24. In another embodiment, the fixing portion 58 may be fixed to another member constituting the instrument panel 24. In addition, the lower cover 38 need not have the body portion 56 and the fixing portion 58. For example, the lower cover 38 may be supported by fitting clips of another component into attachment holes in the body portion 56.

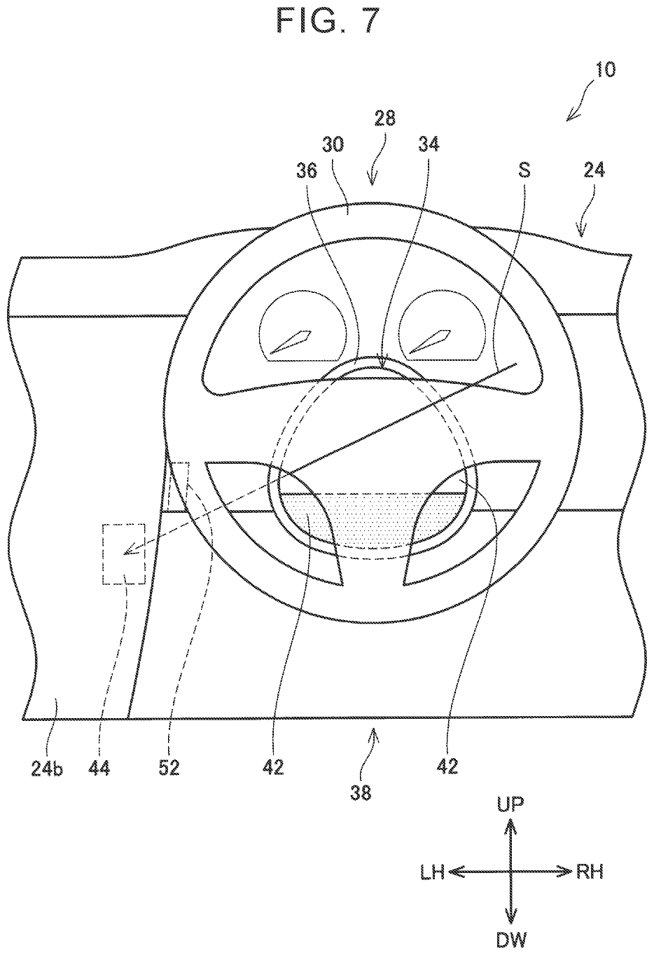

For example, as illustrated in FIG. 7, the shielding wall 52 is visible through a gap around the steering column 34 in the opening 36 in the instrument panel 24, and the inside air sensor 44 is positioned behind the shielding wall 52 in a line-of-sight direction S in which the shielding wall 52 is visible. According to such a structure, the shielding wall 52 can avoid or reduce the occurrence of a case where the user unexpectedly sees the back surface 25 of the center panel 24b through the gap and recognizes the inside air sensor 44 or the hose 48 connecting the inside air sensor 44 and the air conditioning unit 46. Therefore, the design in the vehicle cabin 12c is improved.

For example, the shielding wall 52 may be provided on the instrument panel 24 such as the base panel 24a or the center panel 24b in place of the example described above. In this case, the shielding wall 52 may be integrated with the instrument panel 24 or may be provided as a separate component from the instrument panel 24.

While the several specific examples have been described in detail above, these are only illustrative and do not limit the scope of the claims. The technology defined in the claims includes various modifications and alterations of the specific examples described above. The technical elements described herein or in the drawings exhibit their technical usefulness alone or in combination.

What is claimed is:

1. A vehicle comprising:
a steering column;
a radiant heater arranged in the steering column and configured to radiate radiant heat toward an area below the steering column;
an instrument panel that defines part of an opening where the steering column passes, the instrument panel extending in a lateral direction of the vehicle;
an inside air sensor adjoining the opening in the instrument panel and configured to detect an indoor temperature of the vehicle; and
a lower cover arranged below the steering column and defining the opening together with the instrument panel, wherein at least either one of the instrument panel and the lower cover includes a shielding wall positioned between the radiant heater and the inside air sensor.

2. The vehicle according to claim 1, wherein the shielding wall is provided on the lower cover.

3. The vehicle according to claim 2, wherein the shielding wall is integrated with the lower cover.

4. The vehicle according to claim 2, wherein the shielding wall is covered with the instrument panel.

5. The vehicle according to claim 4, wherein
the shielding wall extends in a front-rear direction of the vehicle from the lower cover toward the instrument panel, and
an end of the shielding wall that faces a back surface of the instrument panel extends along the back surface of the instrument panel.

6. The vehicle according to claim 5, wherein a clearance is provided between the end of the shielding wall and the back surface of the instrument panel.

7. The vehicle according to claim 6, wherein the end of the shielding wall extends along the back surface of the instrument panel to keep the clearance uniform.

8. The vehicle according to claim 2, wherein
the lower cover includes a body portion arranged below the steering column, and a fixing portion extending from the body portion toward the instrument panel and fixed to the instrument panel, and
the shielding wall is integrated with the fixing portion.

9. The vehicle according to claim 1, wherein
the shielding wall is visible through a gap around the steering column in the opening in the instrument panel, and
the inside air sensor is positioned behind the shielding wall in a line-of-sight direction in which the shielding wall is visible.

10. The vehicle according to claim 1, further comprising an airbag arranged on an inner side of the lower cover, wherein the lower cover is configured to be broken by the airbag when the airbag is inflated.
